(19) United States
(12) Patent Application Publication
(10) Pub. No.: US 2025/0360991 A1
(43) Pub. Date: Nov. 27, 2025

(54) PERSONAL WATERCRAFT

(71) Applicant: YAMAHA HATSUDOKI KABUSHIKI KAISHA, Iwata (JP)

(72) Inventors: William Andrew HAMMOND, Atlanta, GA (US); Nicholas Henry REAVES, Marietta, GA (US)

(21) Appl. No.: 19/294,636

(22) Filed: Aug. 8, 2025

Related U.S. Application Data
(63) Continuation of application No. 18/802,680, filed on Aug. 13, 2024.
(60) Provisional application No. 63/519,582, filed on Aug. 15, 2023.

(51) Int. Cl. B63B 34/10; B63B 11/00; F02N 11/08

(52) U.S. Cl. CPC B63B 34/10; B63B 11/00; F02N 11/0862

(57) ABSTRACT

A personal watercraft is provided that comprises a hull, a deck, a saddle seat, and a handlebar. The deck is provided to an upper portion of the hull. The saddle seat is supported by the deck and positioned in a center of the personal watercraft. The handlebar is disposed in the center of the personal watercraft and above the deck in front of the saddle seat. The deck includes a first lateral storage recess and a first storage hatch configured to be opened to expose the first lateral storage recess and closed to cover the first lateral storage recess. The first lateral storage recess has a front end disposed in front of a rear edge of the saddle seat and a rear end disposed adjacent a rear end of the hull. The first storage hatch has a planar surface forming a portion of an upper surface of the deck.

### CROSS-REFERENCE TO RELATED APPLICATIONS

This is a continuation application of U.S. patent application Ser. No. 18/802,680 filed on Aug. 13, 2024, which claims the benefit of U.S. Provisional Application No. 63/519,582, filed on Aug. 15, 2023. The entire disclosures of U.S. patent application Ser. No. 18/802,680 and U.S. Provisional Application No. 63/519,582 are hereby incorporated herein by reference.

### BACKGROUND

### Field of the Invention

The present invention generally relates to the field of personal watercrafts. More specifically, the present invention relates to a personal watercraft with a deck.

### Background Information

Personal watercrafts (PWC) are a small, jet-powered watercraft that resembles a snowmobile in appearance having a hull, a deck, a saddle seat, and a handlebar. Personal watercrafts are designed to be operated on water by a person sitting, standing, or kneeling on the vessel. In some cases, the deck is formed as a flat deck for allowing a rider to walk around the personal watercraft and/or for carrying loads thereon. Since personal watercrafts are relatively small water vessels, typically, the personal watercraft has limited surface area on the deck.

### SUMMARY

It is desirable to have a flat deck with a larger surface area for allowing a rider to easily walk around the personal watercraft and for increasing carrying capacity of the personal watercraft on the deck. On the other hand, at the same time, it is also important to increase riding comfort of the personal watercraft and/or to increase storage capacity of storage containers or storage compartments for various storing items.

Generally, the present disclosure is directed to various features of a personal watercraft.

In view of the state of the known technology and in accordance with one aspect of the present disclosure, a personal watercraft is provided that comprises a hull, a deck, a saddle seat, and a handlebar. The hull has a front end and a rear end. The deck is provided to an upper portion of the hull. The saddle seat is supported by the deck and positioned in a center of the personal watercraft with respect to a lateral direction of the personal watercraft. The handlebar is disposed in the center of the personal watercraft and above the deck in front of the saddle seat. The deck includes a first lateral storage recess and a first storage hatch configured to be opened to expose the first lateral storage recess and closed to cover the first lateral storage recess. The first lateral storage recess has a front end disposed in front of a rear edge of the saddle seat and a rear end disposed adjacent the rear end of the hull. The first storage hatch has a planar surface forming a portion of an upper surface of the deck.

While the disclosed watercraft is a personal watercraft, some features of the disclosed watercraft can be used with other types of watercrafts. Thus, some features of the disclosed watercraft are not limited to personal watercraft.

Also other features, aspects and advantages of the disclosed watercraft will become apparent to those skilled in the field of manufacturing personal watercrafts from the following detailed description, which, taken in conjunction with the annexed drawings, discloses several illustrative embodiments of a personal watercraft with various features.

### BRIEF DESCRIPTION OF THE DRAWINGS

Referring now to the attached drawings which form a part of this original disclosure:

FIG. 1 is a left side (port) perspective view of a watercraft in the form of a personal watercraft (PWC) in accordance with one illustrative embodiment;

FIG. 2 is a front perspective view of the personal watercraft illustrated in FIG. 1, showing a lid of a bow storage container is closed;

FIG. 3 is a left side (port) elevational view of the personal watercraft illustrated in FIG. 1;

FIG. 4 is a right side (starboard) elevational view of the personal watercraft illustrated in FIG. 1;

FIG. 5 is a top plan view of the personal watercraft illustrated in FIG. 1;

FIG. 6 is a left side (port) elevational view of the personal watercraft illustrated in FIG. 1, with portions of a watercraft body broken away to show the bow storage container, an engine and a propulsion unit.

FIG. 7 is a front perspective view of the personal watercraft illustrated in FIG. 1, showing the lid of the bow storage container is open;

FIG. 8 is a lateral cross-sectional view of the personal watercraft illustrated in FIG. 1, taken along VIII-VIII line in FIG. 5.

FIG. 9 is a lateral cross-sectional view of the personal watercraft illustrated in FIG. 1, taken along IX-IX line in FIG. 5.

FIG. 10 is a lateral cross-sectional view of the personal watercraft illustrated in FIG. 1, taken along X-X line in FIG. 5.

FIG. 11 is a rear perspective view of the personal watercraft illustrated in FIG. 1, showing left and right lids of left and right rear storage containers are open.

FIG. 12 is a longitudinal cross-sectional view of the personal watercraft illustrated in FIG. 1, taken along XII-XII line in FIG. 5.

FIG. 13 is a rear perspective view of the personal watercraft illustrated in FIG. 1, with a seat extension unit attached to a saddle seat.

FIG. 14 is a rear perspective view of the personal watercraft illustrated in FIG. 1, with the seat extension unit removed from the saddle seat to show a recess or storage space behind the saddle seat.

FIG. 15 is a rear perspective view of the personal watercraft illustrated in FIG. 1, with the seat extension unit removed from the saddle seat and a hatch attached behind the saddle seat to close the recess or storage space.

FIG. 16 is a left side (port) perspective view of the personal watercraft illustrated in FIG. 1, showing the seat extension unit attached to the saddle seat and a box storage attached behind the seat extension unit.

FIG. 17 is a left side (port) perspective view of the personal watercraft illustrated in FIG. 1, showing the seat extension unit removed from the saddle seat and a box storage attached behind the saddle seat.

FIG. 18 is a left side (port) perspective view of the personal watercraft illustrated in FIG. 1, showing the seat extension unit removed from the saddle seat and two box storages attached behind the saddle seat.

FIG. 19 is a left side (port) perspective view of the personal watercraft illustrated in FIG. 1, showing the seat extension unit removed from the saddle seat, two box storages attached behind the saddle seat and a box storage attached in front of a front steering cowl portion.

FIG. 20 is a longitudinal cross-sectional view of the personal watercraft illustrated in FIG. 1, taken along XII-XII line in FIG. 5, showing an extra battery installed in a left rear storage container.

It should be noted that these figures are intended to illustrate the general characteristics of methods, structure and/or materials utilized in certain illustrative embodiments and to supplement the written description provided below. These drawings are not to scale and may not precisely reflect the precise structural or performance characteristics of any given embodiment, and should not be interpreted as defining or limiting the range of values or properties encompassed by illustrative embodiments unless specified. The use of similar or identical reference numbers in the various drawings is intended to indicate the presence of a similar or identical element or feature.

### DETAILED DESCRIPTION OF EMBODIMENTS

Selected embodiments will now be explained with reference to the drawings. It will be apparent to those skilled in the watercraft field from this disclosure that the following descriptions of the embodiments are provided for illustration only and not for the purpose of limiting the invention as defined by the appended claims and their equivalents. Like reference numerals in the drawings denote like similar or identical elements or features, and thus the descriptions of the similar or identical elements or features may be omitted in later embodiments.

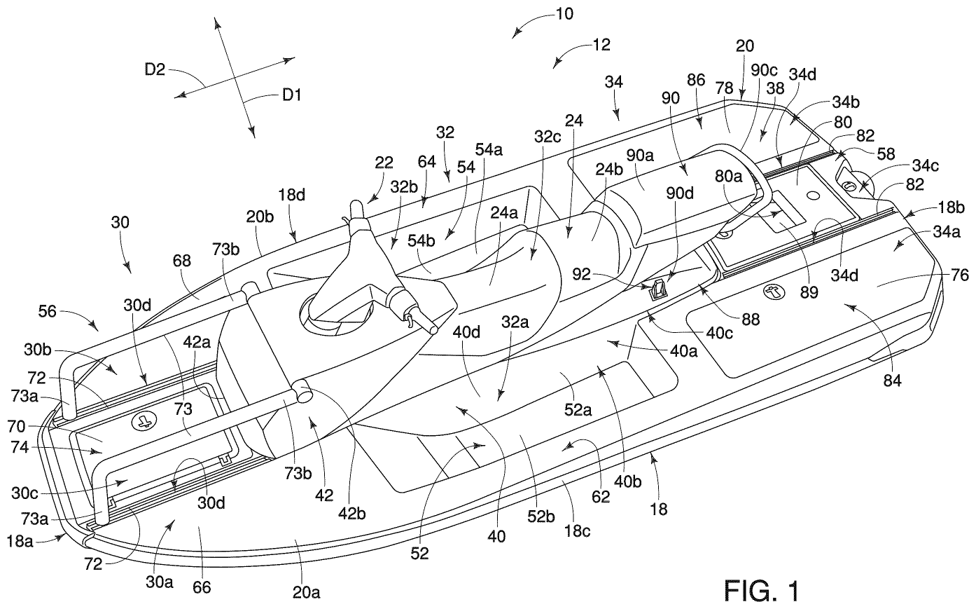

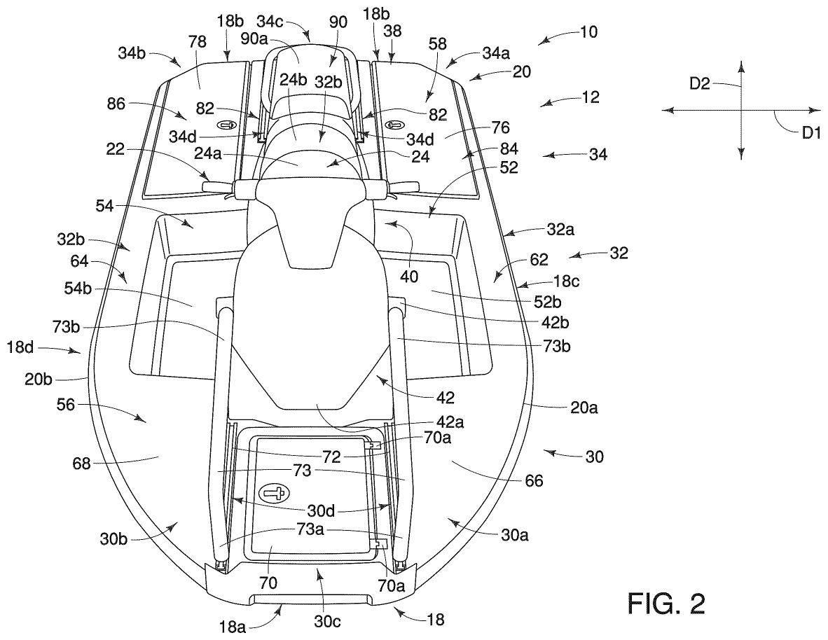

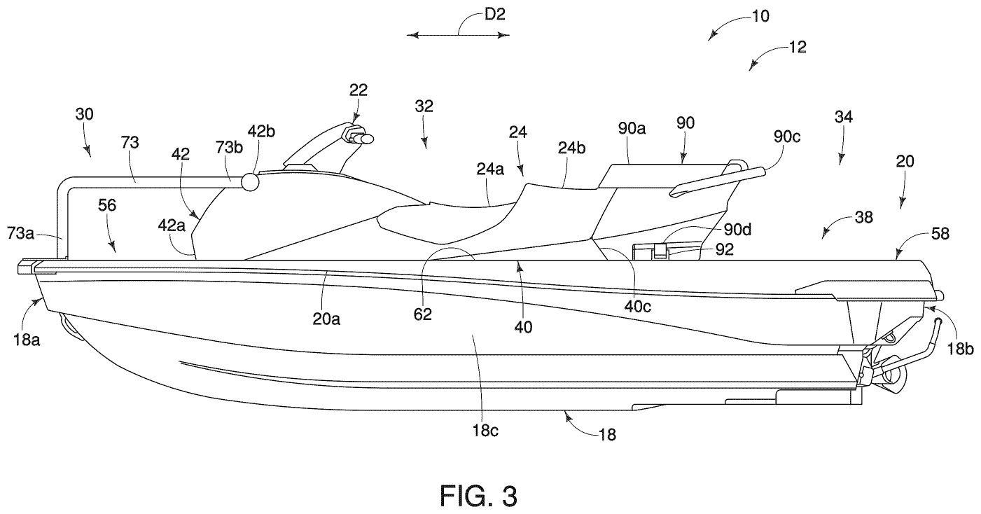

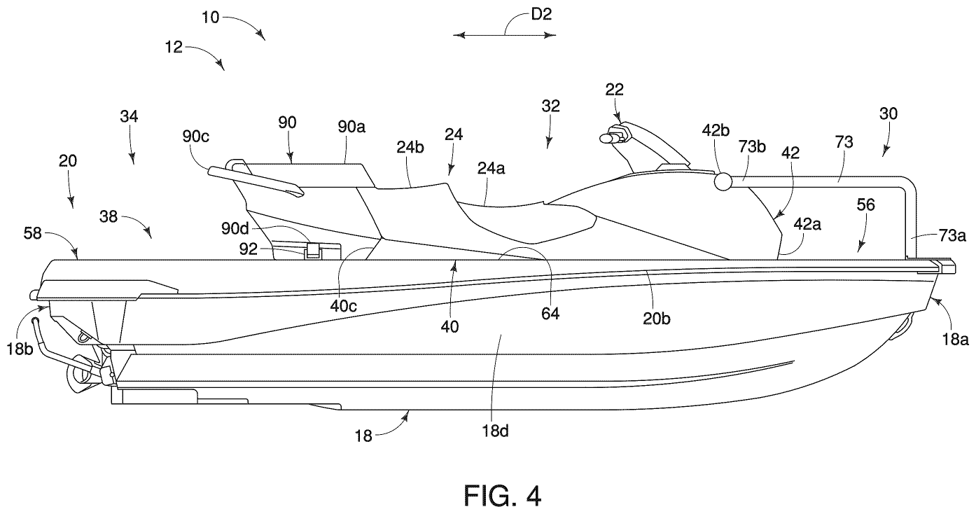

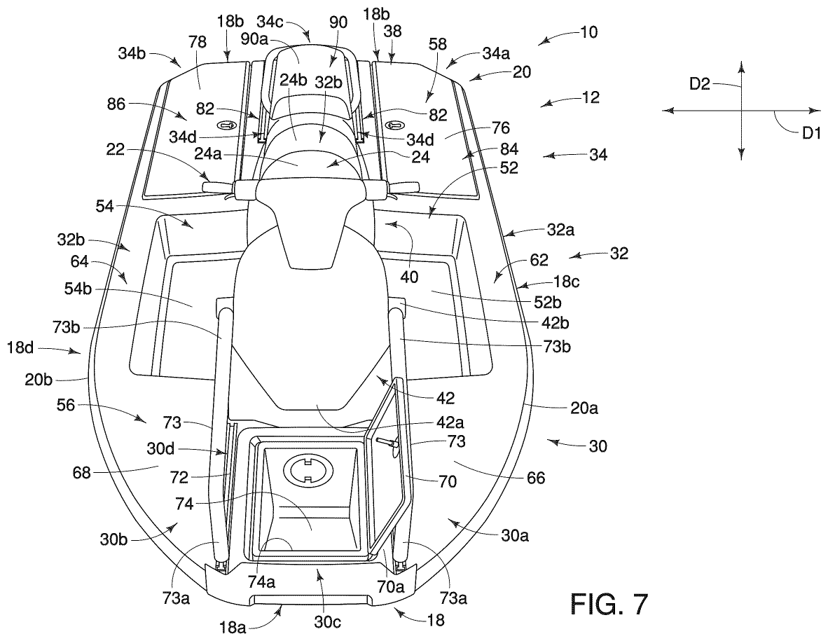

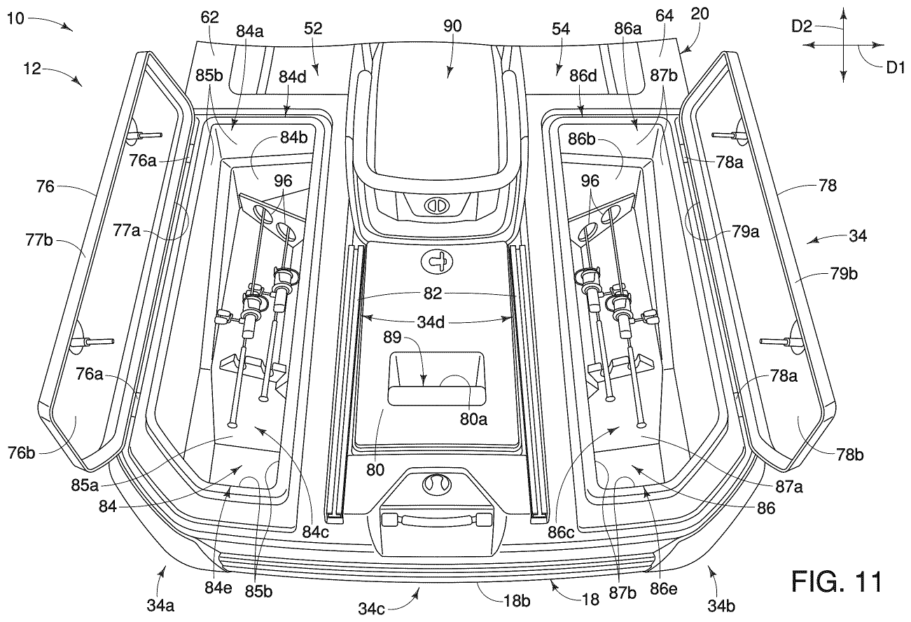

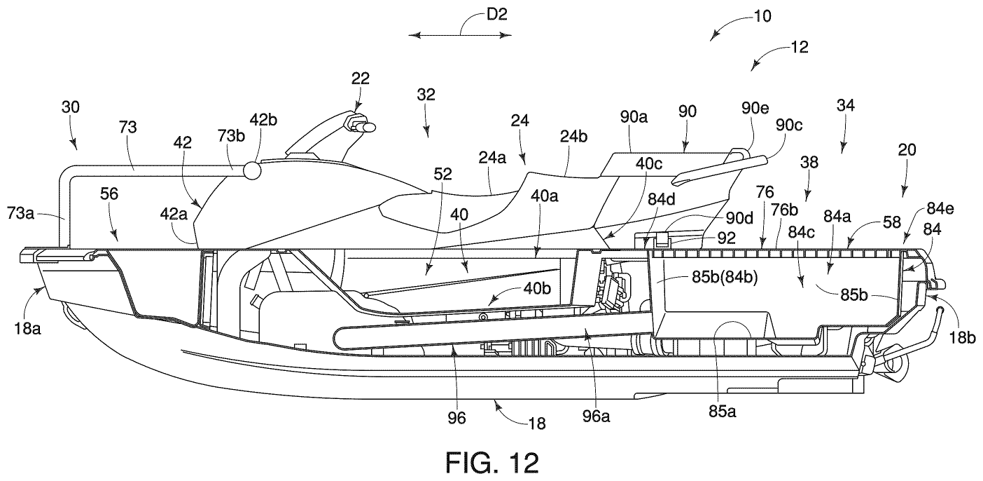

Referring initially to FIGS. 1 to 15, a watercraft 10 is illustrated in the form of a personal watercraft (PWC) in accordance with one illustrative embodiment. While the watercraft 10 is illustrated as a personal watercraft, it will be apparent to those skilled in the watercraft field from this disclosure that the watercraft 10 is not limited to this illustrated configuration of a personal watercraft. The present invention can be provided to other types of watercrafts.

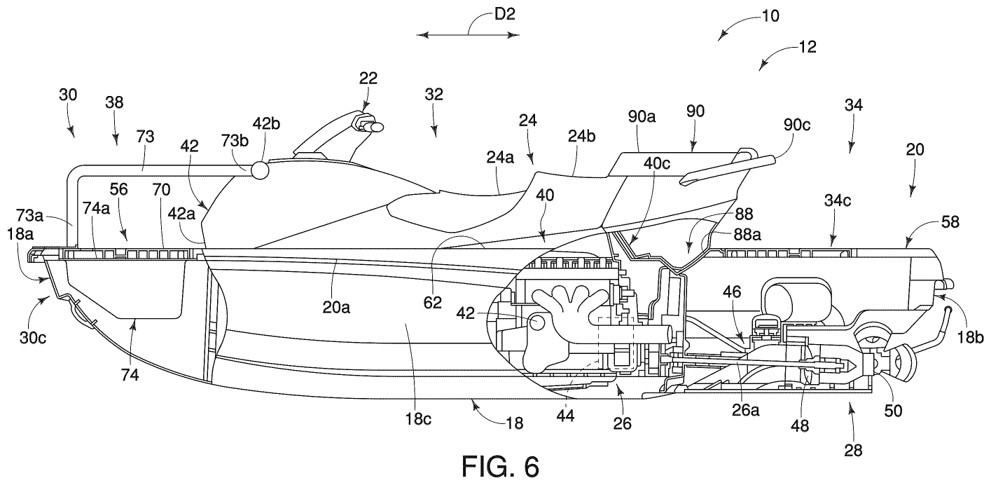

As seen in FIGS. 1 to 6, the watercraft 10 basically comprises a watercraft body 12 with a hull 18 and a deck 20, a handlebar 22, and a saddle or straddle seat 24. As also seen in FIG. 6, the watercraft 10 further comprises an engine 26 and a jet propulsion unit 28.

The hull 18 has a front end 18a and a rear end 18b. The hull 18 also has a first or left (port) side 18c and a second or right (starboard) side 18d. The deck 20 is provided on the hull 18 in a conventional manner. Specifically, the deck 20 is provided to an upper portion of the hull 18. Preferably, the hull 18 and the deck 20 are integrated to form a unit. The deck 20 includes a foredeck 30, a mid-deck 32 and an aftdeck 34. The foredeck 30 is located in the front of the deck 20. The mid-deck 32 is located in the middle of the deck 20 between the foredeck 30 and the aftdeck 34. The aftdeck 34 is located in the rear of the deck 20. The deck 20 also includes a planar surface portion 38, a seat support portion 40 and a front steering cowl portion 42. In the illustrated embodiment, the hull 18, the deck 20 and the other parts of the watercraft body 12 are made of suitable materials that are typically used in watercrafts for a marine environment. Thus, the materials of the hull 18, the deck 20 and the other parts of the watercraft body 12 will not be discussed in detail herein.

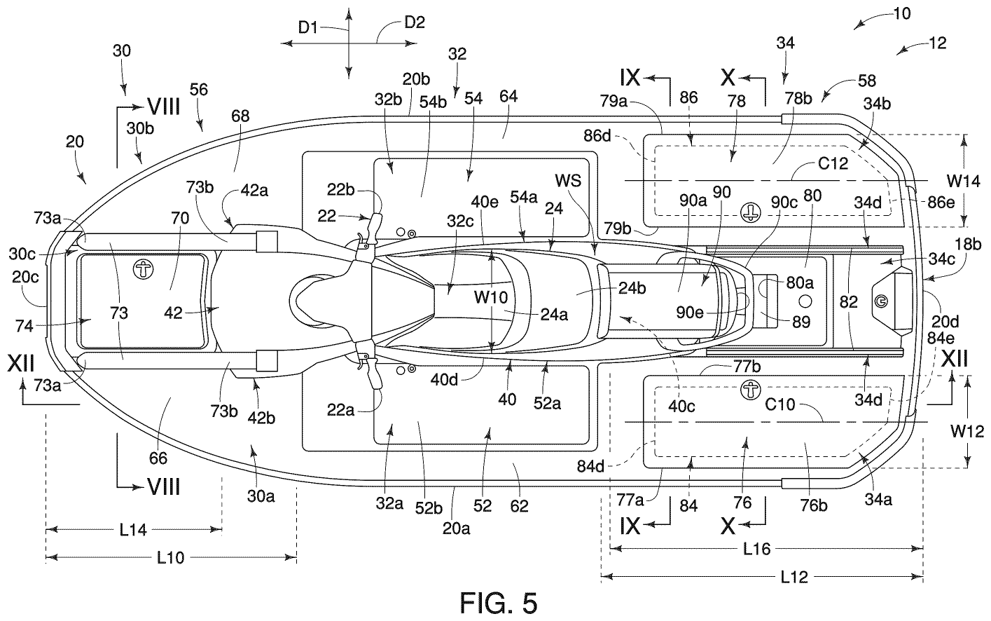

The handlebar 22 is turnably supported on the deck 20 in a conventional manner. Here, the handlebar 22 is a bar-type steering handle that is turnably disposed relative to the watercraft body 12 for steering the watercraft 10. The handlebar 22 is positioned in the center of the watercraft 10 with respect to a lateral direction D1 of the watercraft 10 and above the deck 20 in front of the saddle seat 24. The saddle seat 24 is supported by the deck 20. The saddle seat 24 is detachably attached to the deck 20 by fasteners (not shown) in a conventional manner. The saddle seat 24 is positioned in the center of the watercraft 10 with respect to the lateral direction D1. The saddle seat 24 is supported by an upper end 40a of the seat support portion 40. The saddle seat 24 is also disposed on the deck 20 at a rearward location of the handlebar 22. In the illustrated embodiment, the saddle seat 24 includes a first or front seating portion 24a and a second or rear seating portion 24b. The front seating portion 24a forms an operator or driver seat of the watercraft 10. The rear seating portion 24b is located higher than the front seating portion 24a and forms a passenger seat of the watercraft 10. In the illustrated embodiment, the saddle seat 24 has a layer structure with three layers having a seat cover, a seat padding and a seat core. The seat cover is the outermost layer, providing water resistance and durability, and made of marine-grade vinyl, for example. The seat padding is disposed beneath the seat cover, and is typically made of polyurethane form, for example, which cushions impact and improves comfort. The seat core is the innermost layer, and is typically made of molded plastic or FRP. As seen in FIG. 5, the saddle seat 24 is narrow at the front and rear ends, and has a maximum lateral width W10 at its middle portion, at which the seat cover covers the seat padding. In particular, in the illustrated embodiment, the saddle seat 24 has the maximum lateral width W10 at a location adjacent to an interface between the front seating portion 24a and the rear seating portion 24b.

As seen in FIG. 6, the engine 26 and the jet propulsion unit 28 are disposed on the hull 18 inside of the watercraft body 12. The saddle seat 24 is disposed above the engine 26. Preferably, the saddle seat 24 is detachably mounted to the deck 20 for accessing an interior area of the watercraft body 12 where the engine 26 and the jet propulsion unit 28 are disposed. A fuel tank (not shown) is also disposed on a front portion of the hull 18 inside of the watercraft body 12. As also seen in FIG. 6, a starter motor 42 is attached and operatively connected to the engine 26 to initiate the operation of the engine 26. In the illustrated embodiment, the starter motor 42 includes an electric starter motor, for example. The starter motor 42 is actuated when DC power is supplied from a first or starting battery 44 having a power capacity to operate the starter motor 42. In the illustrated embodiment, the starting battery 44 is disposed on the right side of the engine 26. However, the starting battery 44 is not limited to this location. Since the fuel tank, the engine 26, the starter motor 42 and the starting battery 44 are conventional parts of a personal watercraft, these conventional parts will not be discussed or illustrated in detail herein.

The jet propulsion unit 28 is also a conventional device in the watercraft field, and thus the jet propulsion unit 28 will be only briefly discussed and illustrated herein. Basically, the jet propulsion unit 28 includes a housing 46, an impeller 48 and a steering nozzle 50. The housing 46 is mounted on the hull 18. The housing 46 has a water inlet and a water outlet. The impeller 48 is rotatably mounted inside the housing 46 between the water inlet and the water outlet. The steering nozzle 50 is pivotally mounted relative to the housing 46 at a location rearward of the water outlet. The steering nozzle 50 is operatively connected to the handlebar 22 in a conventional manner such as using cables and/or linkages. The impeller 48 of the jet propulsion unit 28 is operatively connected to a drive shaft 26a of the engine 26. In this way, rotation of the drive shaft 26a by the engine 26 rotates the impeller 48 inside the housing 46. This rotation of the impeller 48 sucks water into the housing 46 via the water inlet and then forces the water at a higher velocity from the housing 46 through the steering nozzle 50 via the water outlet.

Now, the configurations of the deck 20 will be discussed in more detail. As mentioned above, the deck 20 includes the planar surface portion 38, the seat support portion 40 and the front steering cowl portion 42. The deck 20 further includes a first or left lateral recess 52 and a second or right lateral recess 54 that are recessed below the planar surface portion 38 adjacent to a lower end 40b of the seat support portion 40. The left and right lateral recesses 52 and 54 forms footwells that are designed to accommodate the feet of a person riding the watercraft 10, such as a driver, a passenger, etc.

The planar surface portion 38 forms a flat deck surface (e.g., an upper surface) of the deck 20 disposed about the saddle seat 24. Specifically, the planar surface portion 38 includes a bow planar surface 56 and a rear planar surface 58. The bow planar surface 56 is located in the foredeck 30 of the deck 20. In particular, the bow planar surface 56 is located in front of the left and right lateral recesses 52 and 54 and a front edge 42a of the front steering cowl portion 42. The rear planar surface 58 is located in the aftdeck 34 of the deck 20. The rear planar surface 58 is located behind the left and right lateral recesses 52 and 54 and a rear edge 40c of the seat support portion 40. The planar surface portion 38 also includes a first or left gunwale planar surface 62 and a second or right gunwale planar surface 64. The bow planar surface 56 and the rear planar surface 58 are connected by the left and right gunwale planar surfaces 62 and 64. The left gunwale planar surface 62 is located in the mid-deck 32 of the deck 20. The left gunwale planar surface 62 is located laterally outward of the left lateral recess 52. The right gunwale planar surface 64 is also located in the mid-deck 32 of the deck 20. The right gunwale planar surface 64 is located laterally outward of the right lateral recess 54. Thus, in the illustrated embodiment, the deck 20 further includes the left and right gunwale planar surfaces 62 and 64 (e.g., gunwale planar surfaces). In the illustrated embodiment, the bow planar surface 56, the rear planar surface 58 and the left and right gunwale planar surfaces 62 and 64 lie substantially in a same plane. The phrase “substantially in a same plane” as used herein refers to the surfaces being either even or deviate by a predetermined height, such as ±fifty millimeters from the same plane, or more preferably ±twenty-five millimeters from the same plane. Here, the bow planar surface 56, the rear planar surface 58 and the left and right gunwale planar surfaces 62 and 64 are illustrated in the same plane. In this way, a person can freely walk or easily access around the saddle seat 24 without having to step over a bulwark or the like.

As mentioned above, the bow planar surface 56 is located in the foredeck 30 of the deck 20. In the illustrated embodiment, the foredeck 30 is generally defined as an area of the deck 20 that is located in front of a front lateral line or axis that passes through a frontmost point of the left and right lateral recesses 52 and 54 and is parallel to the lateral direction D1. The foredeck 30 includes a left foredeck section 30a, a right foredeck section 30b and a center foredeck section 30c disposed between the left and right foredeck sections 30a and 30b. The center foredeck section 30c is generally defined as an area of the foredeck 30 that is located between left and right longitudinal lines or axes that pass through inner or inboard ends of the left and right lateral recesses 52 and 54, respectively, and are parallel to the longitudinal direction D2. The left and right foredeck sections 30a and 30b are defined as areas of the foredeck 30 that are located outside or outboard relative to the center foredeck section 30c in the lateral direction D1, respectively.

In the illustrated embodiment, the left and right foredeck sections 30a and 30b are located directly in front of the left and right lateral recesses 52 and 54, respectively. The center foredeck section 30c is directly located in front of the front edge 42a of the front steering cowl portion 42 and located in the center of the watercraft 10 with respect to the lateral direction D1. In the illustrated embodiment, the center foredeck section 30c is shorter than the left and right foredeck sections 30a and 30b in the longitudinal direction D2. The left foredeck section 30a laterally extends from a first or left lateral edge 20a of the deck 20 to the center foredeck section 30c, while the right foredeck section 30b laterally extends from a second or right lateral edge 20b of the deck 20 to the center foredeck section 30c. In the illustrated embodiment, the bow planar surface 56 includes left and right foredeck panels 66 and 68 that are disposed in the left and right foredeck sections 30a and 30b, respectively. The bow planar surface 56 includes a lid 70 that is disposed in the center of the watercraft 10 with respect to the lateral direction D1. In particular, the lid 70 is disposed in the center foredeck section 30c. The left and right foredeck panels 66 and 68 and the lid 70 are separately formed from each other, and have upper surfaces that lie in the same horizontal plane. Thus, the bow planar surface 56 extends generally horizontal.

In the illustrated embodiment, the foredeck 30 is divided or partitioned into the left and right foredeck sections 30a and 30b and the center foredeck section 30c. The foredeck 30 also includes a pair of parallel grooves 30d that extend in the longitudinal direction D2 near boundaries between the left and right foredeck sections 30a and 30b and the center foredeck section 30c. In the illustrated embodiment, the grooves 30d are located on the boundaries between the left and right foredeck sections 30a and 30b and the center foredeck section 30c. However, the locations of the grooves 30d are not limited to this. The grooves 30d can be entirely located in the center foredeck section 30c, or can be entirely located in the left and right foredeck sections 30a and 30b, respectively. Furthermore, one of the grooves 30d can be entirely located in the center foredeck section 30c, and the other one of the grooves 30d can be entirely located in the left foredeck section 30a or the right foredeck section 30b.

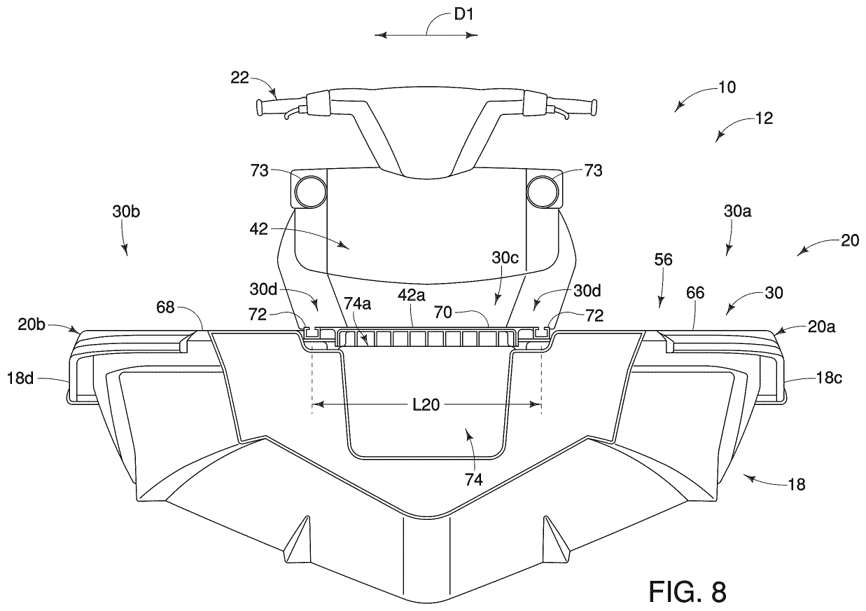

The bow planner surface 56 includes a pair of parallel foredeck rails or slides 72 disposed in the grooves 30d, respectively. In particular, the foredeck rails 72 are provided as accessary fixation structures for fixing watercraft accessories relative to the watercraft 10. In the illustrated embodiment, the foredeck rails 72 are track rails, such as T-tracks, for example. In particular, the foredeck rails 72 each have upper surfaces that are separated by a slot for accommodating fasteners, such as T-track bolts, for fixing the watercraft accessories. The foredeck rails 72 are fixedly coupled to the deck 20 within the grooves 30d using fasteners, such as bolts, screws, etc., such that the foredeck rails 72 does not protrude from the bow planar surface 56 and such that the slots of the foredeck rails 72 open upward, as seen in FIG. 8. In the illustrated embodiment, the upper surfaces of the foredeck rails 72 also substantially lie in the same horizontal plane as the upper surfaces of the left and right foredeck panels 66 and 68 and the lid 70. Thus, the bow planar surface 56 is continuous from the left lateral edge 20a of the deck 20 to the right lateral edge 20b of the deck 20. In particular, the bow planar surface 56 is continuous without being interrupted by any gaps or bumps that can interfere with a person walking on or accessing to the bow planar surface 56.

In the illustrated embodiment, the watercraft 10 further comprises a pair of handrails or bow rails 73 (e.g., at least one handrail). The bow rails 73 are removably attached to the foredeck 30 of the deck 20. The bow rails 73 each have a first or front end 73a and a second or rear end 73b (e.g., an end portion). The front ends 73a of the bow rails 73 are fixedly coupled to the foredeck rails 72, respectively. The rear ends 73b of the bow rails 73 are disposed above the planar surface portion 38 and spaced apart from the planar surface portion 38. The rear ends 73b of the bow rails 73 are fixedly coupled or connected to attachment portions 42b of the front steering cowl portion 42, respectively. In the illustrated embodiment, the bow rails 73 are fixedly coupled to the foredeck rails 72 via mounting brackets that are fastened to the foredeck rails 72. In this way, the bow rails 73 extend forward from the rear ends 73b at the front steering cowl portion 42 and downward to the front end 73a at the bow planar surface 56. In the illustrated embodiment, the bow rails 73 are fixedly coupled to the foredeck rails 72. However, the locations of the bow rails 73 are not limited to this. The front ends 73a of the bow rails 73 can be fixed to other locations of the foredeck 30, other than the foredeck rails 72. Here, the term “handrail” in the present disclosure does not necessarily mean that the function thereof is limited to providing a gripping surface for passengers to hold onto by their hands. The handrail can also serve various other purposes, including securing accessories or items on the watercraft 10. Thus, in the illustrated embodiment, the bow rails 73 can be utilized not only for providing a gripping surface for passengers but also for securing accessories and items as accessory mounts.

As seen in FIGS. 6 to 8, the foredeck 30 of the deck 20 further includes a first or bow storage container or compartment 74. The bow storage container 74 is located in the center foredeck section 30c between the front end 18a of the hull 18 and the front edge 42a of the front steering cowl portion 42 in the longitudinal direction D2. The bow storage container 74 has an access opening 74a that opens upward in the center foredeck section 30c. The lid 70 is pivotally coupled to the center foredeck section 30c using a pair of hinges 70a. Specifically, the lid 70 is movable between an open position that exposes the access opening 74a and a closed position that covers the access opening 74a. In this way, the lid 70 forms a part of the flat deck surface of the deck 20 while the lid 70 is in the closed position. Thus, in the illustrated embodiment, the bow storage container 74 is located below the bow planar surface 56 of the planar surface portion 38.

In the illustrated embodiment, as seen in FIG. 8, the bow storage container 74 is entirely located in the center foredeck section 30c in the lateral direction D1. However, the location of the bow storage container 74 is not limited to this. The bow storage container 74 can be laterally extended such that the bow storage container 74 is partially disposed in the left and right foredeck sections 30a and 30b, while the access opening 74a is disposed in the center foredeck section 30c.

As mentioned above, the rear planar surface 58 is located in the aftdeck 34 of the deck 20. In the illustrated embodiment, the aftdeck 34 is generally defined as an area of the deck 20 that is located behind of a rear lateral line or axis that passes through a rearmost point of the left and right lateral recesses 52 and 54 and is parallel to the lateral direction D1. The aftdeck 34 includes a left aftdeck section 34a, a right aftdeck section 34b and a center aftdeck section 34c disposed between the left and right foredeck sections 34a and 34b. The center aftdeck section 34c is generally defined as an area of the aftdeck 34 that is located between the left and right longitudinal lines or axes that pass through the inner or inboard ends of the left and right lateral recesses 52 and 54, respectively, and are parallel to the longitudinal direction D2. The left and right aftdeck sections 34a and 34b are defined as areas of the aftdeck 34 that are located outside or outboard relative to the center aftdeck section 34c in the lateral direction D1, respectively.

In the illustrated embodiment, the left and right aftdeck sections 34a and 34b are located directly behind the left and right lateral recesses 52 and 54, respectively. The center aftdeck section 30c is directly located behind the rear edge 40c of the seat support portion 40 and located in the center of the watercraft 10 with respect to the lateral direction D1. In the illustrated embodiment, the center aftdeck section 34c is shorter than the left and right aftdeck sections 34a and 34b in the longitudinal direction D2. The left aftdeck section 34a laterally extends from the left lateral edge 20a of the deck 20 to the center aftdeck section 34c, while the right aftdeck section 34b laterally extends from the right lateral edge 20b of the deck 20 to the center aftdeck section 34c. In the illustrated embodiment, the rear planar surface 58 includes left and right lids 76 and 78 (e.g., first and second storage hatch) that are disposed in the left and right aftdeck sections 34a and 34b, respectively. The rear planar surface 58 includes a center aftdeck panel 80 that is disposed in the center aftdeck section 34c. The left and right lids 76 and 78 and the center aftdeck panel 80 are separately formed from each other, and have upper surfaces that lie in the same horizontal plane. Thus, the rear planar surface 58 extends generally horizontal.

In the illustrated embodiment, the aftdeck 34 is divided or partitioned into the left and right aftdeck sections 34a and 34b and the center aftdeck section 34c. The aftdeck 34 also includes a pair of parallel grooves 34d that extend in the longitudinal direction D2 near boundaries between the left and right aftdeck sections 34a and 34b and the center aftdeck section 34c. In the illustrated embodiment, the grooves 34d are located on the boundaries between the left and right aftdeck sections 34a and 34b and the center aftdeck section 34c. However, the locations of the grooves 34d are not limited to this. The grooves 34d can be entirely located in the center aftdeck section 34c, or can be entirely located in the left and right aftdeck sections 34a and 34b, respectively. Furthermore, one of the grooves 34d can be entirely located in the center aftdeck section 34c, and the other one of the grooves 34d can be entirely located in the left aftdeck section 34a or the right aftdeck section 34b.

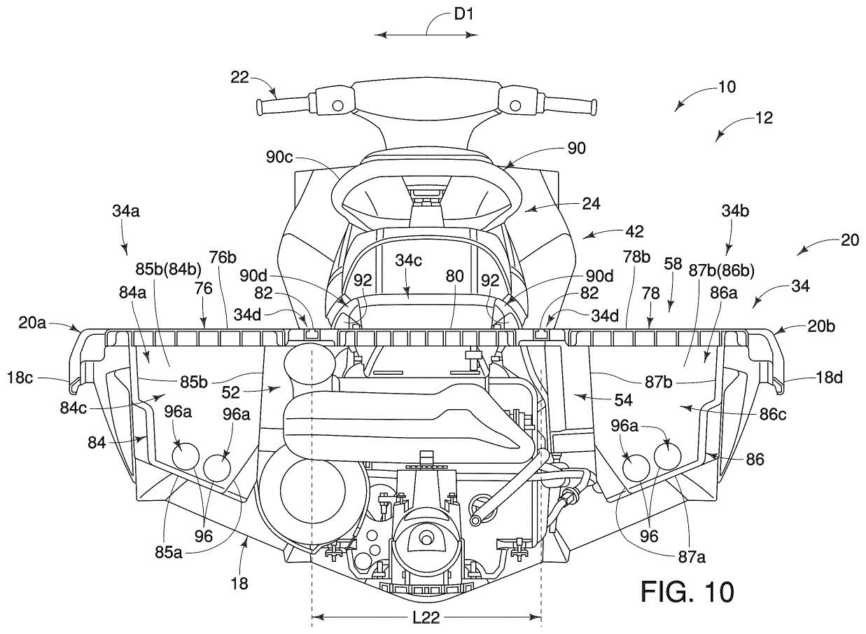

The rear planner surface 58 includes a pair of parallel aftdeck rails or slides 82 disposed in the grooves 34d, respectively. In particular, the aftdeck rails 82 are provided as accessary fixation structures for fixing watercraft accessories relative to the watercraft 10. In the illustrated embodiment, the aftdeck rails 82 are track rails, such as T-tracks, for example. In particular, the aftdeck rails 82 each have upper surfaces that are separated by a slot for accommodating fasteners, such as T-track bolts, for fixing the watercraft accessories. The aftdeck rails 82 are fixedly coupled to the deck 20 within the grooves 34d using fasteners, such as bolts, screws, etc., such that the aftdeck rails 82 does not protrude from the rear planar surface 58 and such that the slots of the aftdeck rails 82 open upward, as seen in FIG. 10. In the illustrated embodiment, the upper surfaces of the aftdeck rails 82 also substantially lie in the same horizontal plane as the upper surfaces of the left and right lids 76 and 78 and the center aftdeck panel 80. Thus, the rear planar surface 58 is continuous from the left lateral edge 20a of the deck 20 to the right lateral edge 20d of the deck 20. In particular, the rear planar surface 58 is continuous without being interrupted by any gaps or bumps that can interfere with a person walking on or accessing to the rear planar surface 58.

In the illustrated embodiment, as seen in FIG. 5, the bow planar surface 56 mainly includes the left and right foredeck panels 66 and 68 and the lid 70, while the rear planar surface 58 mainly includes the left and right lids 76 and 78 and the center aftdeck panel 80. The bow planar surface 56 has an overall length L10 measured between a front edge 20c of the deck 20 and the frontmost point of the left and right lateral recesses 52 and 54 (i.e., the front lateral line or axis) in the longitudinal direction D2. The rear planar surface 58 has an overall length L12 measured between the rearmost point of the left and right lateral recesses 52 and 54 (i.e., the rear lateral line or axis) and a rear edge 20d of the deck 20 in the longitudinal direction D2. In the illustrated embodiment, the length L12 of the rear planar surface 58 is greater than the length L10 of the bow planar surface 56. Thus, the rear planar surface 58 is longer in the longitudinal direction D2 than the bow planar surface 56. Furthermore, in the illustrated embodiment, a length L14 measured between the front edge 20 of the deck 20 and the front edge 42a of the front steering cowl portion 42 is smaller than a length L16 measured between the rear edge 40c of the seat support portion 40 and the rear edge 20d of the deck 20. Furthermore, in the illustrated embodiment, the left and right lids 76 and 78 have a larger surface area than the left and right foredeck panels 66 and 68, respectively, and the center aftdeck panel 80 has a larger surface area than the lid 70. Thus, the rear planar surface 58 has a larger surface area than the bow planar surface 56.

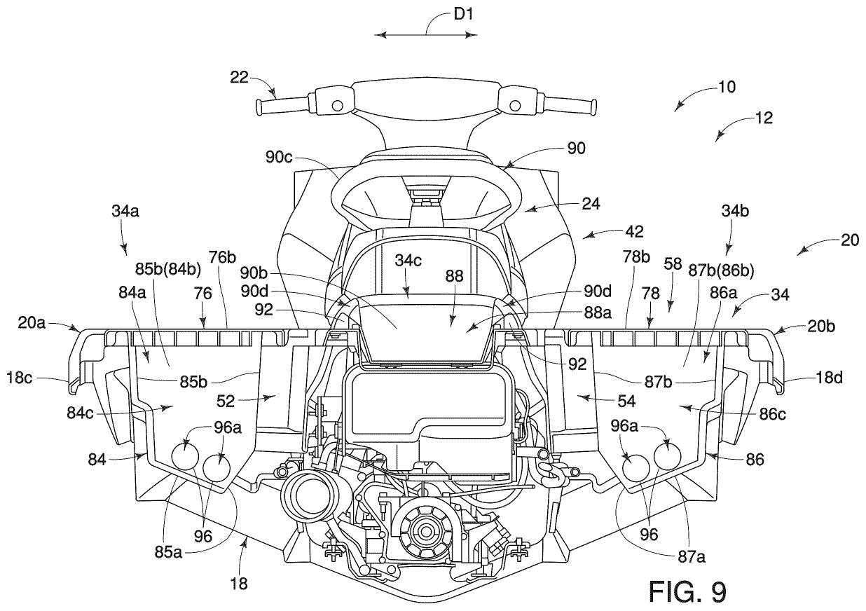

As seen in FIGS. 9 to 12, the aftdeck 34 of the deck 20 further includes left and right rear storage containers or compartments 84 and 86 (e.g., first and second lateral storage recesses). Thus, the deck 20 includes the left rear storage container 84 and the left lid 76. Also, the deck 20 includes the right rear storage container 86 and the right lid 76. The left rear storage container 84 is located in the left aftdeck section 34a between the rear end 18b of the hull 18 and the left lateral recess 52 in the longitudinal direction D2, while the right rear storage container 86 is located in the right aftdeck section 34b between the rear end 18b of the hull 18 and the right lateral recess 54 in the longitudinal direction D2. The left and right rear storage containers 84 and 86 have access openings 84a and 86a (e.g., upper entrance opening) that open upward in the left and right aftdeck sections 34a and 34b, respectively. Specifically, as seen in FIGS. 9 to 12, the left rear storage container 84 of the deck 20 includes a bottom storage wall 85a (e.g., a first bottom storage wall) and a plurality of side storage walls 85b (e.g., a plurality of first side storage walls) defining the access opening 84a (e.g., the upper entrance opening) of the left rear storage container 84. The right rear storage container 86 of the deck 20 includes a bottom storage wall 87a (e.g., a second bottom storage wall) and a plurality of side storage walls 87b (e.g., a plurality of second side storage walls) defining the access opening 86a (e.g., the upper entrance opening) of the right rear storage container 86. In the illustrated embodiment, each of the bottom storage walls 85a and 87a include multiple planar sections that are continuous to each other. In particular, in the illustrated embodiment, the multiple planar sections of each of the bottom storage walls 85a and 87a are inclined at different angles in the lateral direction D1, but are not substantially inclined in the longitudinal direction D2. Of course, each of the bottom storage walls 85a and 87a can be formed as a single continuous planar section. In either case, the bottom storage walls 85a and 87a define the lowermost positions of the left and right rear storage containers 84 and 86, respectively, and the lowermost positions are contained within vertical projection ranges of the access openings 84a and 86a, respectively. In the illustrated embodiment, the left lid 76 is at least as large as the bottom storage wall 85a of the left rear storage container 84 of the deck 20. Similarly, the right 78 is at least as large as the bottom storage wall 87a of the right rear storage container 86 of the deck 20. Thus, in the illustrated embodiment, the bottom storage walls 85a and 87a do not extend outward beyond upper peripheral edges of the access openings 84a and 86a, respectively, but are contained within vertical projection ranges of the access openings 84a and 86a, respectively. In particular, when the lids 76 and 78 are opened, the entire bottom storage walls 85a and 87a are visible. Furthermore, the side storage walls 85b and 87b defining the access openings 84a and 86a downwardly extend from upper peripheral edges of the access openings 84a and 86a to the bottom storage walls 85a and 87a without diverging outward, respectively. The side storage walls 85b and 87b are formed without any undercuts, but functional openings, such as ventilation holes or holes for providing extension portions 96, which will be described later, may be formed in the side storage walls 85b and 87b. In the illustrated embodiment, each of the side storage walls 85b and 87b include multiple stepped sections that are continuous to each other. Of course, each of the side storage walls 85b and 87b can be formed as a single continuous planar section.

As seen in FIG. 5, the left lid 76 and the right lid 78 are mirror images. In the illustrated embodiment, the left lid 76 includes an outboard edge 77a and an inboard edge 77b. In particular, the outboard edge 77a and the inboard edge 77b are substantially parallel to each other, and laterally separated by a lateral width of the left lid 76 relative to each other, which is the maximum lateral width W12 of the left lid 76. The outboard edge 77a is hinged to the deck 20. The inboard edge 77b is disposed laterally outward of the saddle seat 24. In the illustrated embodiment, the maximum lateral width W12 of the left lid 76 is at least three-fourth of the maximum lateral width W10 of the saddle seat 24. Also, the maximum lateral width W12 of the left lid 76 is slightly smaller than the maximum lateral width W10 of the saddle seat 24. Furthermore, the right lid 78 includes an outboard edge 79a and an inboard edge 79b. In particular, the outboard edge 79a and the inboard edge 79b are substantially parallel to each other, and laterally separated by a lateral width of the right lid 76 relative to each other, which is the maximum lateral width W14 of the right lid 78. The outboard edge 79a is hinged to the deck 20. The inboard edge 79b is disposed laterally outward of the saddle seat 24. In the illustrated embodiment, the maximum lateral width W14 of the right lid 78 is at least three-fourth of the maximum lateral width W10 of the saddle seat 24. Also, the maximum lateral width W14 of the right lid 78 is slightly smaller than the maximum lateral width W10 of the saddle seat 24. Specifically, the left and right lids 76 and 78 are pivotally coupled to the left and right aftdeck sections 34a and 34b using hinges 76a and 78a, respectively. Specifically, the left and right lids 76 and 78 are movable between an open position that exposes the access openings 84a and 86a and a closed position that covers the access openings 84a and 86a. Thus, the left lid 76 is configured to be opened to expose the left rear storage container 84 and closed to cover the left rear storage container 84. Also, the right lid 78 is configured to be opened to expose the right rear storage container 86 and closed to cover the right rear storage container 86. The left and right lids 76 and 78 have planar upper surfaces 76b and 78b (e.g., planar surfaces), respectively. In this way, the planar upper surfaces 76b and 78b of the left and right lids 76 and 78 each form a part of the flat deck surface (e.g., a portion of the upper surface) of the deck 20 while the left and right lids 76 and 78 are in the closed position. Thus, in the illustrated embodiment, the left and right rear storage containers 84 and 86 are located below the rear planar surface 58 of the planar surface portion 38.

In the illustrated embodiment, as seen in FIGS. 9 and 10, the left and right rear storage containers 84 and 86 are entirely located in the left and right aftdeck sections 34a and 34b in the lateral direction D1, respectively. In particular, as also seen in FIG. 5, a longitudinal center line C10 of the left rear storage container 84 is disposed laterally outside of a left end 22a of the handlebar 22 on the left (port) side (e.g., the first lateral side) of the watercraft 10. Also, a longitudinal center line C12 of the right rear storage container 86 is disposed laterally outside of a right end 22b of the handlebar 22 on the right (starboard) side (e.g., the second lateral side) of the watercraft 10. In other words, the left rear storage container 84 and the right storage rear container 86 have the longitudinal center lines C10 and C12 that are disposed laterally outward of the left and right ends (e.g., the outer ends) 22a and 22b of the handlebar 22. In particular, the longitudinal center lines C10 and C12 of the left and right rear storage containers 84 and 86 are disposed laterally outward of the left and right ends 22a and 22b of the handlebar 22, respectively, while the handlebar 22 is at a straight steering position, as seen in FIG. 5. Here, the longitudinal center lines C10 and C12 extend through the centers of the left and right rear storage containers 84 and 86 with respect to the lateral direction D1 and extends in a direction parallel to the longitudinal direction D2. However, the locations of the left and right rear storage containers 84 and 86 are not limited to these locations. The left rear storage container 84 can be laterally extended such that the left rear storage container 84 is partially disposed in the center aftdeck section 34c, while the access opening 84a is disposed in the left aftdeck section 34a. Similarly, the right rear storage container 86 can be laterally extended such that the right rear storage container 86 is partially disposed in the center aftdeck section 34c, while the access opening 86a is disposed in the right aftdeck section 34b.

In the illustrated embodiment, the center aftdeck panel 80 is detachably and reattachably attached to the center aftdeck section 34c. The center aftdeck panel 80 includes an aperture 80a through which a reboarding grip 89 provided to the center aftdeck section 34c can be held. Also, when the center aftdeck panel 80 is detached, a clean-out port (not shown) provided to the center aftdeck section 34 can be accessed.

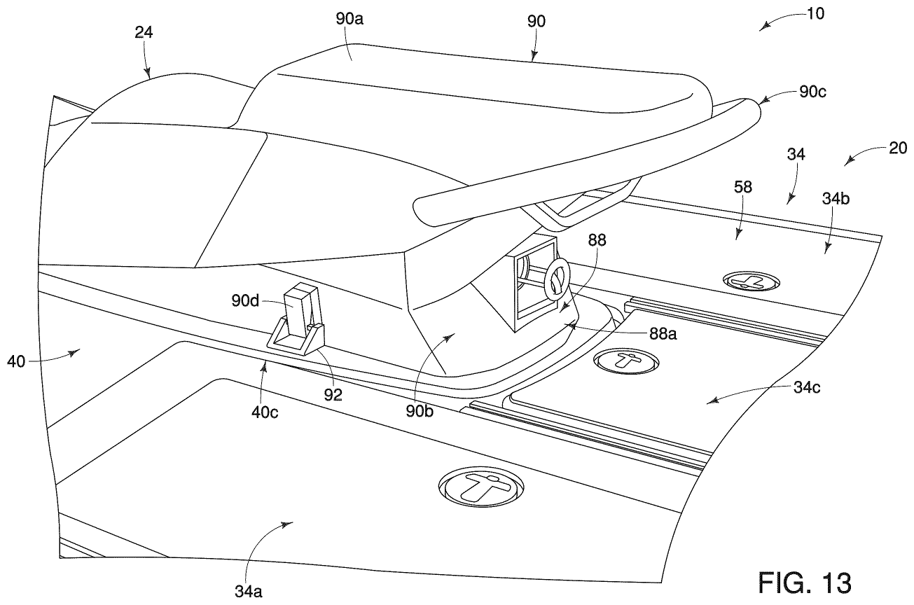

In the illustrated embodiment, the aftdeck 34 of the deck 20 further includes a recess 88 that is recessed from the rear planar surface 58. The recess 88 is located between the rear edge 40c of the seat support portion 40 and the center aftdeck panel 80 in the longitudinal direction D2 and between the left and right aftdeck section 34a and 34b in the lateral direction D1. In the illustrated embodiment, the watercraft 10 further comprises a seat extension unit 90 (e.g., a rear seat extension portion) attached to the saddle seat 24 such that the seat extension unit 90 is at least partially disposed above the rear planar surface 58. Specifically, the seat extension unit 90 includes a seating portion 90a that forms an extra passenger seat of the watercraft 10. The seat extension unit 90 also includes a base portion 90b and a passenger hand grip 90c. The seat extension unit 90 is detachably and reattachably attached to the saddle seat 24. When the seat extension unit 90 is attached to the saddle seat 24, a front end of the seating portion 90a covers a rear end of the saddle seat 24. In this way, when the seat extension unit 90 is attached to the saddle seat 24, the seat extension unit 90 provides an extra passenger seat of the watercraft 10 at a location higher than the saddle seat 24. Furthermore, when the seat extension unit 90 is attached to the saddle seat 24, the base portion 90b is at least partly disposed inside the recess 88, as seen in FIGS. 6 and 9. In other words, the recess 88 receives the base portion 90b (e.g., the part of the rear seat extension portion) for supporting the seat extension unit 90 while the seat extension unit 90 is attached to the saddle seat 24. Thus, when the seat extension unit 90 is attached to the saddle seat 24, an access opening 88a of the recess 88 that opens upward is covered by the seat extension unit 90, as seen in FIG. 13. In the illustrated embodiment, the seat extension unit 90 also includes a pair of latches 90d for selectively engaging a pair of receivers 92 provided to the aftdeck 34 adjacent to the recess 88 to retain the seat extension unit 90 relative to the aftdeck 34. In the illustrated embodiment, the receivers 92 are provided as a left and right pair, and are spaced apart from each other in the lateral direction D1. In particular, the receivers 92 are provided on the left and right sides of the recess 88 to sandwich the recess 88 therebetween in the lateral direction D1.

In the illustrated embodiment, the seat extension unit 90 has a layer structure with three layers having a seat cover, a seat padding and a seat core. The seat cover is the outermost layer, providing water resistance and durability, and made of marine-grade vinyl, for example. The seat padding is disposed beneath the seat cover, and is typically made of polyurethane form, for example, which cushions impact and improves comfort. The seat core is the innermost layer, and is typically made of molded plastic or FRP. In the illustrated embodiment, the saddle seat 24 and the seat extension unit 90 are independently formed as separate members, but they are integrally formed as a one-piece member. When the seat extension unit 90 is attached to or integrated with the saddle seat 24, the saddle seat 24 and the seat extension unit 90 can be collectively referred to as a watercraft saddle seat WS (e.g., a saddle seat) of the watercraft 10. As seen in FIG. 5, the seat extension unit 90 has a narrower lateral width than the saddle seat 24. Thus, the maximum lateral width W10 of the saddle seat 24 also forms the maximum lateral width of the watercraft saddle seat WS. Thus, in the illustrated embodiment, the maximum lateral widths W12 and W14 of the left and right lids 76 and 78 are at least three-fourth of the maximum lateral width W10 of the watercraft saddle seat WS. Furthermore, the inboard edges 77b and 79b of the left and right lids 76 and 78 are disposed laterally outward of the watercraft saddle seat WS. In the illustrated embodiment, the seating portion 90a of the seat extension unit 90 has a rear edge 90e, along which the seat cover covers the seat padding. The rear edge 90e of the seat extension unit 90 also forms a rear edge of the watercraft saddle seat WS. The rear edge 90e of the seat extension unit 90 is located at a longitudinal position that overlaps with the left and right rear storage containers 84 and 86. Thus, in the illustrated embodiment, the left rear storage container 84 has a front end 84d disposed in front of the rear edge 90e of the watercraft saddle seat WS and a rear end 84c disposed adjacent the rear end 18b of the hull 18. Also, the right rear storage container 86 has a front end 86d disposed in front of the rear edge 90e of the watercraft saddle seat WS and a rear end 86e disposed adjacent the rear end 18b of the hull 18. Furthermore, in the illustrated embodiment, the front ends 84d and 86d of the left and right rear storage containers 84 and 86 are disposed rearward of the rear end of the saddle seat 24.

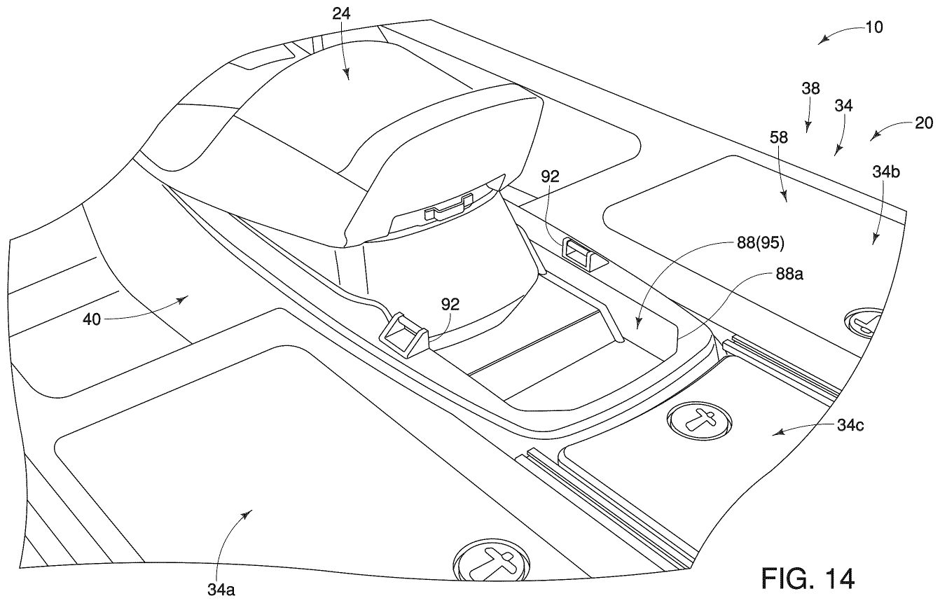

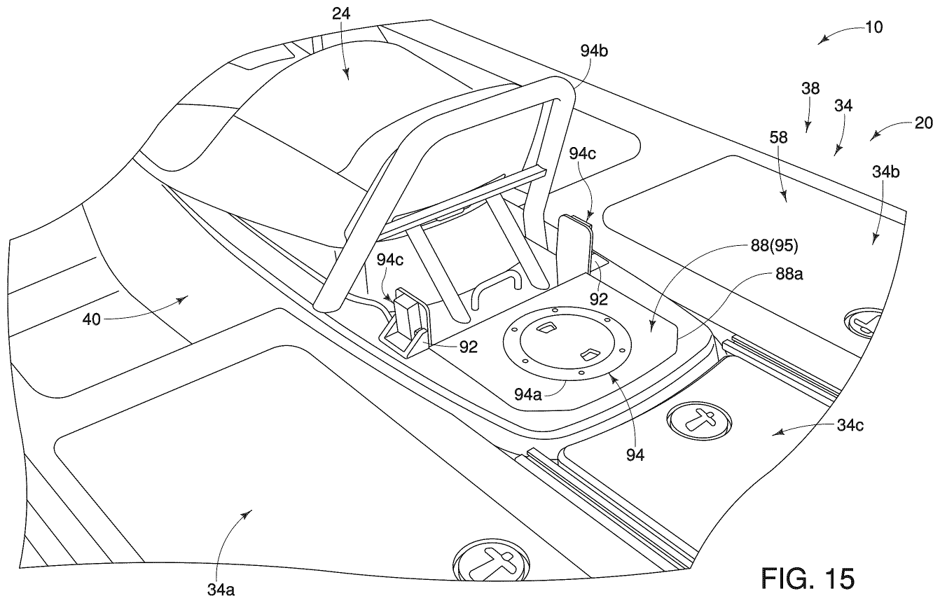

On the other hand, as seen in FIGS. 14 and 15, when the seat extension unit 90 is detached or removed from the saddle seat 24, then a hatch 94 can be installed to cover the recess 88 in replace of the seat extension unit 90. Specifically, the hatch 94 includes a hatch cover 94a that covers the recess 88 and partly defines the rear planar surface 58 when the hatch 94 is attached to the aftdeck 34. Thus, in the illustrated embodiment, the planar surface portion 38 includes the hatch 94 that covers the recess 88 and partly defines the rear planar surface 58. The hatch 94 also includes a passenger hand grip 94b and a pair of latches 94c for selectively engaging the receivers 92 to retain the hatch 94 relative to the aftdeck 34. Thus, the hatch 94 is detachably and reattachably attached to the aftdeck 34. Thus, the hatch 94 is configured to be opened and closed. In particular, when the hatch 94 is detached from the aftdeck 34 and is opened, then the access opening 88a of the recess 88 is exposed, as seen in FIG. 14. On the other hand, when the hatch 94 is attached to the aftdeck 34 and is closed, then the access opening 88a of the recess 88 is covered by the hatch cover 94a of the hatch 94, as seen in FIG. 15. In this case, the recess 88 is disposed below the hatch cover 94a and is covered by the hatch cover 94a, thereby becoming a storage space 95 for storing various items.

In the illustrated embodiment, as seen in FIGS. 9 to 12, at least one extension areas or portions 96 are provided to the left and right rear storage containers 84 and 86. In the illustrated embodiment, a pair of extension portions 96 are provided to each of the left and right rear storage containers 84 and 86. The extension portions 96 are each formed by a tubular member and protrude from front inner walls 84b and 86b, which are ones of the side storage walls 85b and 87b, of the left and right rear storage containers 84 and 86 towards an interior of the hull 18 to define elongated receiving spaces 96a. Specifically, the extension portions 96 extend forward from the front inner walls 84b and 86b of the left and right rear storage containers 84 and 86 such that the elongated receiving spaces 96a communicate to interior storage spaces 84c and 86c of the left and right rear storage containers 84 and 86. The extension portions 96 are located beneath the left and right lateral recesses 52 and 54, respectively and are disposed on each lateral side of the saddle seat 24 in the lateral direction D1 as viewed from above. In this way, the elongated receiving spaces 96a can be provided to the watercraft 10 for storing elongated items, such as fishing rods, flag poles, etc. Here, the extension portions 96 are not limited to these locations. For example, the extension portions 96 can be configured to extend laterally from the left and right rear storage containers 84 and 86 in the lateral direction D1. Also, the extension portions 96 can be configured to extend from other storage containers of the watercraft 10, such as the bow storage container 74. Of course, one or both of the left and right rear storage containers 84 and 86 can be formed without the extension portions 96. In this case, the front inner walls 84b and 86b of the left and right rear storage containers 84 and 86 does not have holes for providing the extension portions 96.

As mentioned above, the left and right gunwale planar surfaces 62 and 64 are located in the mid-deck 32 of the deck 20. As seen in FIG. 5, the mid-deck 32 includes a left mid-deck section 32a, a right mid-deck section 32b and a center mid-deck section 32c disposed between the left and right mid-deck sections 32a and 32b. The left and right gunwale planar surfaces 62 and 64 are located in the left and right mid-deck sections 32a and 32b, respectively. The left and right lateral recesses 52 and 54 are also located in the left and right mid-deck sections 32a and 32b, respectively. The seat support portion 40 is located in the center mid-deck section 32c. The seat support portion 40 also includes left and right side walls 40d and 40e that extends between the upper end 40a and the lower end 40b. The left and right side walls 40d and 40e partly define inner side walls 52a and 52b of the left and right lateral recesses 52 and 54, and extend upward beyond the left and right gunwale planar surfaces 62 and 64, as seen in FIG. 1. Thus, in the illustrated embodiment, the left and right lateral recesses 52 and 54 are laterally separated from each other by the seat support portion 40. The left and right lateral recesses 52 and 54 also include bottom surfaces 52b and 54b, respectively, that are located below the left and right gunwale planar surfaces 62 and 64, respectively. Thus, with the left and right lateral recesses 52 and 54, a proper seating height between the saddle seat 24 (the front seating portion 24a and the rear seating portion 24b) and the bottom surfaces 52b and 54b can be ensured while maintaining the center of gravity of the watercraft 10 at a desired low position, which increases riding comfort of the watercraft 10.

In the illustrated embodiment, as mentioned above, each of the bow planar surface 56 and the rear planar surface 58 includes at least one set of accessory fixation structures. In particular, the bow planar surface 56 includes the pair of the foredeck rails 72, as the accessary fixation structures, while the rear planar surface 58 includes the pair of the aftdeck rails 82, as the accessary fixation structures. In particular, in the illustrated embodiment, the foredeck rails 72 of the bow planar surface 56 and the aftdeck rails 82 of the rear planar surface 58 have the same configuration. For example, the foredeck rails 72 and the aftdeck rails 82 have an identical cross-sectional shape, taken along a plane perpendicular to a longitudinal axis of the foredeck rails 72 and the aftdeck rails 82. Thus, the same fasteners, such as T-track bolts, can be commonly utilized for the foredeck rails 72 and the aftdeck rails 82. Of course, the foredeck rails 72 and the aftdeck rails 82 do not need to be exactly identical to each other, and can at least partially have the same configuration. For example, the foredeck rails 72 and the aftdeck rails 82 can have different configurations, except for a lateral spacing therebetween. In this case, the foredeck rails 72 are spaced apart from each other by the lateral spacing that is equal to the lateral spacing between the aftdeck rails 82. Thus, the same accessory can be selectively attached to the foredeck rails 72 and the aftdeck rails 82 by selectively utilizing appropriate fasteners.

Furthermore, as seen in FIGS. 8 and 10, a first distance L20 between the foredeck rails 72 in the lateral direction D1 and a second distance L22 between the aftdeck rails 82 in the lateral direction D1 is equal to each other. Thus, the same watercraft accessory, such as a box storage, can be interchangeably attached to the foredeck rails 72 or the aftdeck rails 82. In the illustrated embodiment, each of the bow planar surface 56 and the rear planar surface 58 includes at least one set of accessory fixation structures (i.e., the foredeck rails 72 and the aftdeck rails 82). However, only one of the bow planar surface 56 and the rear planar surface 58 can include at least one set of accessory fixation structures. In other words, the bow planar surface 56 can be configured not to include the foredeck rails 72, or the rear planar surface 58 can be configured not to include the aftdeck rails 82. Also, the watercraft 10 can include other accessary fixation structures at various locations on the watercraft 10. For example, the watercraft 10 can further include additional rails at various locations on the deck 20, or include hooks at various locations on the deck 20, as needed and/or desired.

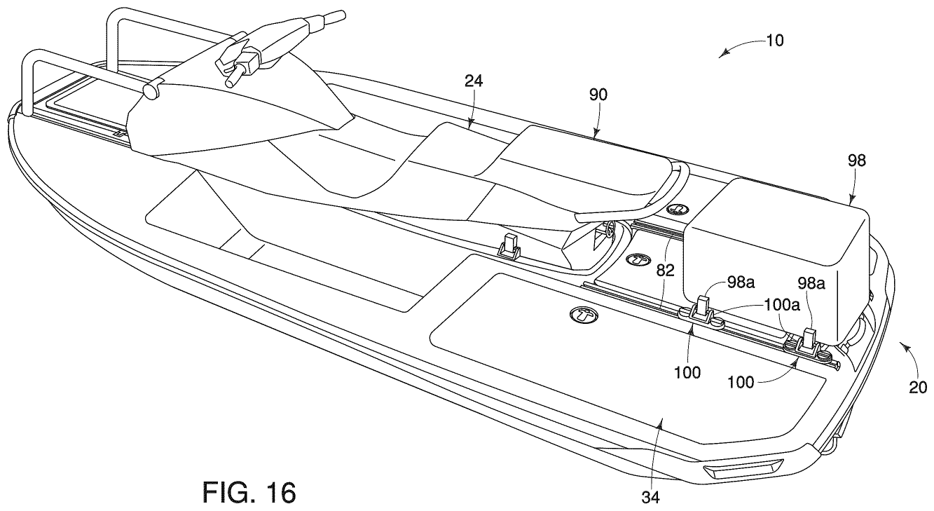

FIGS. 16 to 19 illustrate different arrangements of one or more box storages 98 on the watercraft 10. FIG. 16 illustrates an arrangement in which one box storage 98 is attached to the aftdeck 34 behind the seat extension unit 90 while the seat extension unit 90 is attached to the saddle seat 24. In this case, the box storage 98 is fixedly coupled to the aftdeck rails 82 via mounting brackets 100 that are fixedly coupled to the aftdeck rails 82 using fasteners, such as T-track bolts. In particular, the box storage 98 includes a pair of latches 98a on each lateral side of the box storage 98. The latches 98a of the box storage 98 selectively engage receivers 100a of the mounting brackets 100 to retain the box storage 98 relative to the aftdeck 34.

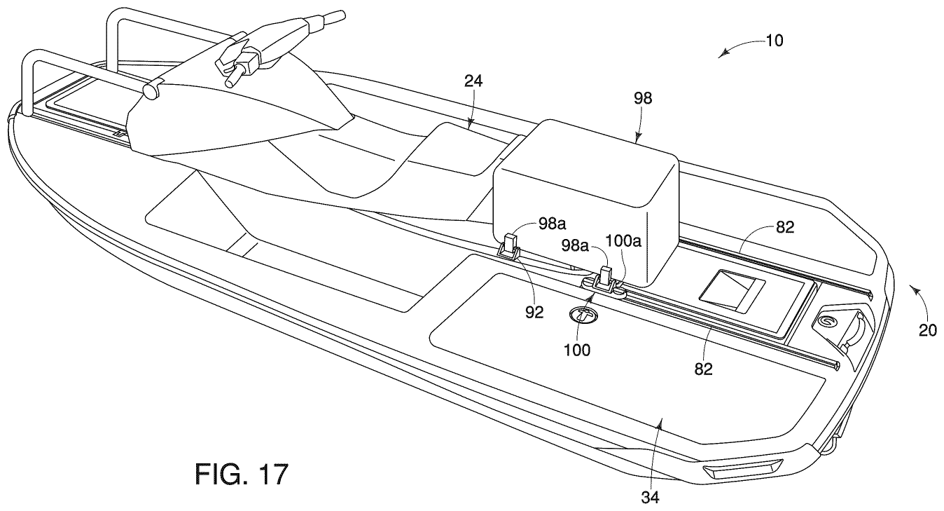

FIG. 17 illustrates an arrangement in which one box storage 98 is attached to the aftdeck 34 behind the saddle seat 24 in replace of the seat extension unit 90 while the seat extension unit 90 is detached from the saddle seat 24. In this case, the box storage 98 is fixedly coupled to the aftdeck 34 using the receivers 92 provided to the aftdeck 34 and the receivers 100a of the mounting brackets 100 that are fixedly coupled to the aftdeck rails 82. Specifically, a front pair of the latches 98a of the box storage 98 engage the receivers 92 provided to the aftdeck 34 and a rear pair of the latches 98a of the box storage 98 engage the receivers 100a of the mounting brackets 100, thereby retaining the box storage 98 relative to the aftdeck 34. In the illustrated embodiment, the receivers 92 are spaced apart from each other in the lateral direction D1 by the same distance as that between the receivers 100a in the lateral direction D1. Of course, the distance between the receivers 92 is not limited to this, and can be the same as that between the aftdeck rails 82 in the lateral direction D1. In the illustrated embodiment, the receivers 92 are positioned in front of front ends of the aftdeck rails 82 in the longitudinal direction D2.

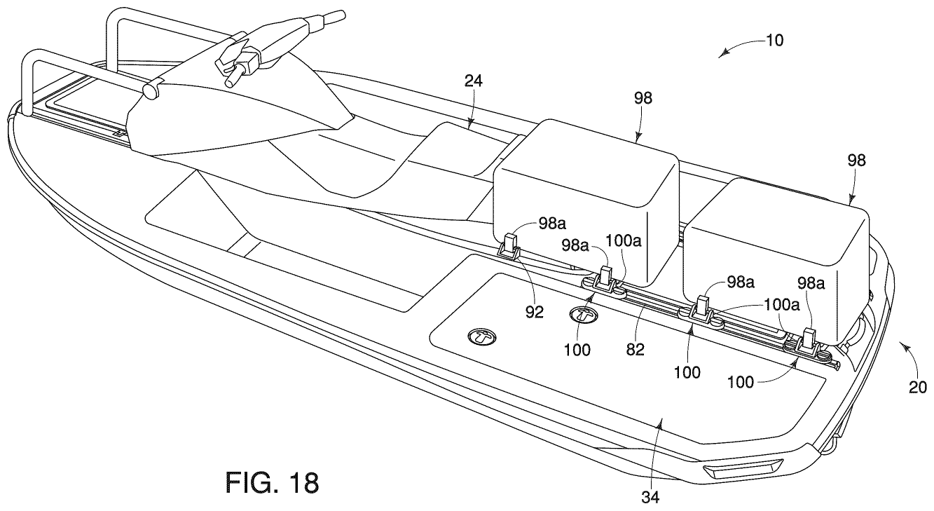

FIG. 18 illustrates an arrangement in which two box storages 98 are attached to the aftdeck 34 behind the saddle seat 24 while the seat extension unit 90 is detached from the saddle seat 24. In this case, a front one of the box storages 98 is fixedly coupled to the aftdeck 34 using the receivers 92 provided to the aftdeck 34 and the receivers 100a of the mounting brackets 100, in the same manner as shown in FIG. 17, while a rear one of the box storages 98 is fixedly coupled to the aftdeck 34 using the receivers 100a of the mounting brackets 100, in the same manner as shown in FIG. 16.

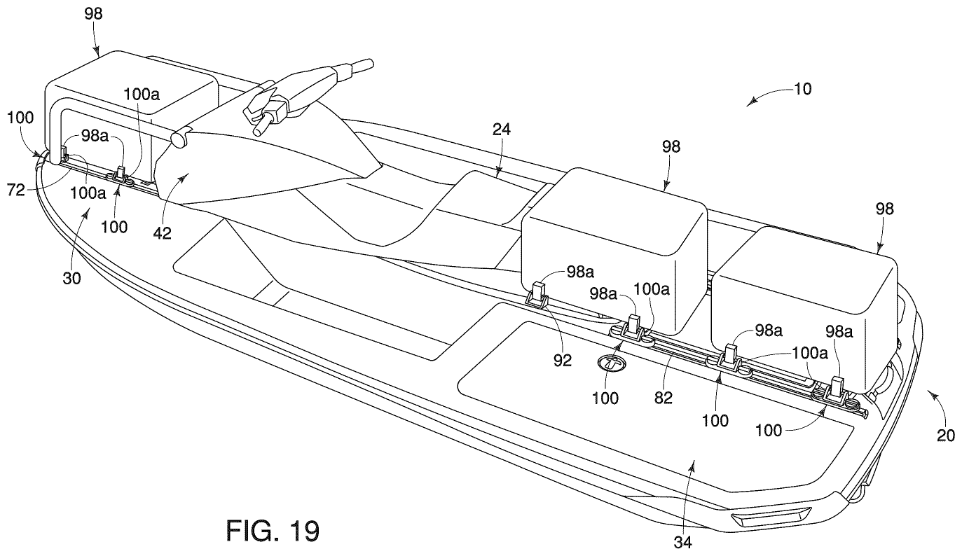

FIG. 19 illustrates an arrangement in which one box storage 98 is attached to the foredeck 30 in front of the front steering cowl portion 42 and two box storages 98 are attached to the aftdeck 34 behind the saddle seat 24 while the seat extension unit 90 is detached from the saddle seat 24. In this case, one box storage 98 is fixedly coupled to the foredeck rails 72 via the mounting brackets 100 that are fixedly coupled to the foredeck rails 72 using fasteners, such as T-track bolts. In particular, the latches 98a of the box storage 98 selectively engage the receivers 100a of the mounting brackets 100 to retain the box storage 98 relative to the foredeck 34. Furthermore, the other two box storages 98 are attached to the aftdeck 34 in the same manner as shown in FIG. 18.

In these examples shown in FIGS. 16 to 19, the box storages 98 are identical to each other, and are a dry box storage, a cooler box, a dry cargo box, etc. However, the box storages 98 can be different from each other, as long as the box storages 98 are attachable to the foredeck 30 and the aftdeck 34 using the foredeck rails 72 and the aftdeck rails 82.

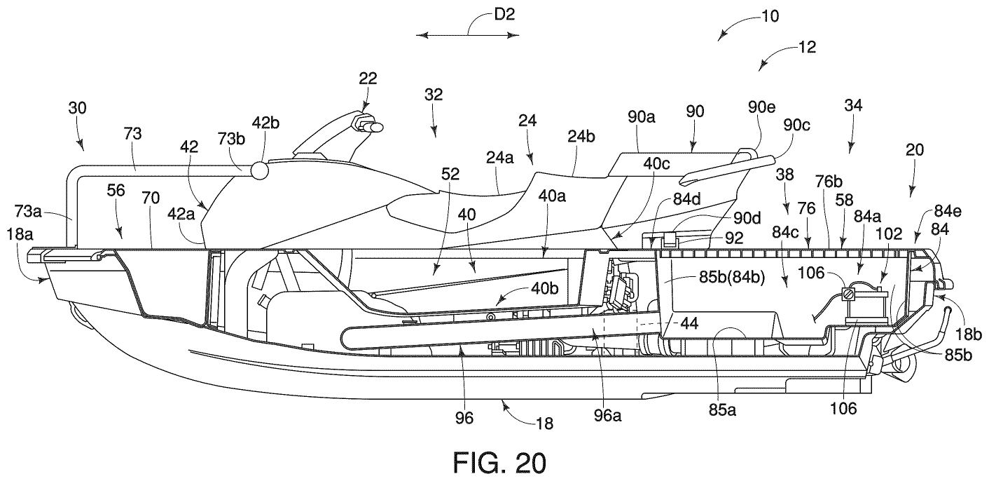

In the illustrated embodiment, as seen in FIG. 20, the watercraft 10 can further include a second or extra battery 102 for supplying electric power to electrical devices or accessories of the watercraft 10, such as an electric cooler box, a trolling motor, a shallow water anchor, various display monitors on the front steering cowl portion 42, etc. The extra battery 102 is provided separate from the starting battery 44 (FIG. 6). In the illustrated embodiment, the extra battery 102 is disposed within the left rear storage container 84. Thus, in the illustrated embodiment, the watercraft 10 comprises the left rear storage container 84 (e.g., the storage area) configured to receive the extra battery 102 separate from the starting battery 44. In particular, the extra battery 102 is supported by a battery tray 104 that is installed within the left rear storage container 84. The extra battery 102 is electrically connected to an electrical accessory (not shown) of the watercraft via a battery switch 106. The battery switch 106 is disposed within the left rear storage container 84 near or on the battery tray 104. The battery switch 106 is configured to selectively turn on and off electric power from the extra battery 102 to an electrical accessory (not shown). Here, the location of the extra battery 102 is not limited to this location. The extra battery 102 can be located within other storage area of the watercraft 10, such as the bow storage container 74, the right rear storage container 86, the storage space 95, etc.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Thus, as used herein, the singular forms “a,” “an” and “the” are intended to include the plural forms as well, unless the context clearly indicates otherwise. Also, the terms “part,” “section,” “portion,” “member” or “element” when used in the singular can have the dual meaning of a single part or a plurality of parts. Unless otherwise defined, all terms (including technical and scientific terms) used herein have the same meaning as commonly understood by one of ordinary skill in the art to which illustrative embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “and/or” includes any and all combinations of one or more of the associated listed items. Additionally, similar words used to describe the relationship between elements or layers should be interpreted in a like fashion (e.g., “between” versus “directly between”, “above” versus “directly above”, “below” versus “directly below”, “adjacent” versus “directly adjacent,” “on” versus “directly on”). Thus, components that are shown directly connected or contacting each other can have intermediate structures disposed between them unless specified otherwise.

It will be understood that, although the terms “first”, “second”, etc. may be used herein to describe various elements, components, regions, layers, positions and/or sections, these elements, components, regions, layers, positions and/or sections should not be limited by these terms. These terms are only used to distinguish one element, component, region, layer, position or section from another element, component, region, layer, position or section. Thus, a first element, component, region, layer, position or section discussed above could be termed a second element, component, region, layer, position or section without departing from the teachings of illustrative embodiments.

Spatially relative terms, such as “forward”, “rearward”, “above”, “below”, “beneath”, “downward”, “vertical”, “horizontal”, and “transverse” as well as any other similar spatial terms may be used herein for the case of description to describe one element or feature's relationship to another element(s) or feature(s) of the above embodiments. These terms, as utilized to describe the present invention should be interpreted relative to a watercraft floating in calm water.

The terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A personal watercraft comprising:
a hull having a front end and a rear end;
a deck provided to an upper portion of the hull;
a saddle seat supported by the deck and positioned in a center of the personal watercraft with respect to a lateral direction of the personal watercraft; and
a handlebar disposed in the center of the personal watercraft and above the deck in front of the saddle seat,
the deck including a first lateral storage recess and a first storage hatch configured to be opened to expose the first lateral storage recess and closed to cover the first lateral storage recess,
the first lateral storage recess having a front end disposed in front of a rear edge of the saddle seat and a rear end disposed adjacent the rear end of the hull,
the first storage hatch having a planar surface forming a portion of an upper surface of the deck.

2. The personal watercraft according to claim 1, wherein
the deck includes a first bottom storage wall and a plurality of first side storage walls defining an upper entrance opening of the first lateral storage recess, and
the first storage hatch is at least as large as the first bottom storage wall.

3. The personal watercraft according to claim 1, wherein
the first storage hatch has a maximum lateral width that is at least three-fourth of a maximum lateral width of the saddle seat.

4. The personal watercraft according to claim 1, wherein
a longitudinal center line of the first lateral storage recess is disposed laterally outside of a first end of the handlebar on a first lateral side of the personal watercraft.

5. The personal watercraft according to claim 1, wherein
the first storage hatch includes an outboard edge that is hinged to the deck.

6. The personal watercraft according to claim 1, wherein
the first storage hatch includes an inboard edge that is disposed laterally outward of the saddle seat.

7. The personal watercraft according to claim 1, wherein
the deck includes a second lateral storage recess and a second storage hatch configured to be opened to expose the second lateral storage recess and closed to cover the second lateral storage recess,
the second lateral storage recess having a front end disposed in front of the rear edge of the saddle seat and a rear end disposed adjacent the rear end of the hull,
the second storage hatch having a planar surface forming a portion of an upper surface of the deck.

8. The personal watercraft according to claim 1, wherein
the deck includes a second bottom storage wall and a plurality of second side storage walls defining an upper entrance opening of the second lateral storage recess, and
the second storage hatch is at least as large as the second bottom storage wall.

9. The personal watercraft according to claim 8, wherein
the second storage hatch has a maximum lateral width that is at least three-fourth of a maximum lateral width of the saddle seat.

10. The personal watercraft according to claim 8, wherein
the first storage hatch and the second storage hatch are mirror images.

11. The personal watercraft according to claim 8, wherein
the first lateral storage recess and the second lateral storage recess have longitudinal center lines that are disposed laterally outward of outer ends of the handlebar.

12. The personal watercraft according to claim 8, wherein
each of the first storage hatch and the second storage hatch includes an outboard edge that is hinged to the deck.

13. The personal watercraft according to claim 8, wherein
each of the first storage hatch and the second storage hatch includes an inboard edge that is disposed laterally outward of the saddle seat.
